(19) United States
(12) Patent Application Publication
(10) Pub. No.: US 2017/0085392 A1
(43) Pub. Date: Mar. 23, 2017

(54) SYSTEM, METHOD AND APPARATUS FOR DATA COMMUNICATION

(71) Applicant: Xiaomi Inc., Beijing (CN)

(72) Inventors: Enxing HOU, Beijing (CN); Xin Liu, Beijing (CN); Yanlu Zhang, Beijing (CN)

(73) Assignee: Xiaomi Inc., Beijing (CN)

(21) Appl. No.: 15/202,346

(22) Filed: Jul. 5, 2016

(30) Foreign Application Priority Data
Sep. 22, 2015 (CN) 201510609698.1

(51) Int. Cl. H04L 12/28; H04L 29/12; H04L 29/08; H04W 4/00; H04L 12/933

(52) U.S. Cl. CPC H04L 12/2816; H04W 4/008; H04L 49/1584; H04L 67/303; H04L 61/6022; H04L 61/6081; H04W 88/16

(57) ABSTRACT

The present disclosure relates to a system, a method and an apparatus for data communication, which belongs to the field of smart home. The system includes: a server, a Zigbee gateway, and at least a Zigbee device, wherein the server is configured to receive a control instruction, wherein the control instruction carries identification of the Zigbee device; the server is configured to forward the control instruction to the Zigbee gateway; the Zigbee gateway is configured to receive the control instruction sent by the server via the target network chip, acquire the identification of the Zigbee device carried in the control instruction; and forward the control instruction to the corresponding Zigbee device via the Zigbee chip; and the Zigbee device is configured to receive the control instruction forwarded by the Zigbee gateway, wherein a network type corresponding to the target network chip is different from that of a Zigbee network.

### PRIORITY STATEMENT

The present application is based upon and claims priority to Chinese Patent Application 201510609698.1, filed Sep. 22, 2015, the entire content of which is incorporated herein by reference.

### TECHNICAL FIELD

The present disclosure generally relates to the field of smart home, and more particularly, to a system, a method and an apparatus for data communication.

### BACKGROUND

Zigbee technology is an IEEE 802.15.4-based technology of high-level communication protocols used to create personal area networks applied in short range and bidirectional wireless communication, having characteristics of low power consumption, low speeds, low costs, and scalability to a large number of network nodes. The Zigbee technology is widely applied in situations where low power consumption is strictly required.

A device using the Zigbee technology is called a Zigbee device. A Zigbee device may be a smog sensor, a smart lamp, electrical meters with in-home-displays, traffic management systems, and other consumer and industrial equipment that requires short-range low-rate wireless data transfer. While transmission distance of a Zigbee device is normally 10-100 meters due to its low power consumption, the ZigBee device can transmit data over long distances by passing data through a mesh network of intermediate devices. A Zigbee network usually has a plurality of Zigbee devices and a Zigbee gateway. Wherein the Zigbee gateway is used to connect respective Zigbee devices for data communication and send the data of respective Zigbee devices to a server in the Internet. For example, the Zigbee gateway may be used to send smog data collected by the smog sensor to the server in the Internet.

### SUMMARY

In order to solve the problem that a mobile terminal cannot send a control instruction to the Zigbee device, the present disclosure provides a system, a method and an apparatus for data communication. The technical solution is as follows.

According to a first aspect of embodiments of the present disclosure, there is provided a system for data communication, wherein the system includes: a server, a Zigbee gateway connected with the server, and at least a Zigbee device connected with the Zigbee gateway, and a target network chip and a Zigbee chip are provided on the Zigbee gateway at the same time, wherein the server is configured to receive a control instruction, wherein the control instruction carries identification of the Zigbee device; the server is configured to forward the control instruction to the Zigbee gateway; the Zigbee gateway is configured to receive the control instruction sent by the server via the target network chip; acquire the identification of the Zigbee device carried in the control instruction; and forward the control instruction to the corresponding Zigbee device via the Zigbee chip; and the Zigbee device is configured to receive the control instruction forwarded by the Zigbee gateway, wherein a network type corresponding to the target network chip is different from that of a Zigbee network.

According to a second aspect of embodiments of the present disclosure, there is provided a method for data communication, including: receiving a control instruction, wherein the control instruction carries identification of a Zigbee device; and forwarding the control instruction to a Zigbee gateway, wherein the Zigbee gateway is configured to receive the control instruction via a target network chip; the Zigbee gateway is further configured to acquire the identification of the Zigbee device carried in the control instruction; and the Zigbee gateway is further configured to forward the control instruction to the Zigbee device corresponding to the identification of the Zigbee device via the Zigbee chip, wherein a network type corresponding to the target network chip is different from that of a Zigbee network.

According to a third aspect of embodiments of the present disclosure, there is provided an apparatus for data communication, including: a processor; and a memory for storing instructions executable by the processor, wherein the processor is configured to: receive a control instruction, wherein the control instruction carries identification of a Zigbee device; and forward the control instruction to a Zigbee gateway, wherein the Zigbee gateway is configured to receive the control instruction via a target network chip; the Zigbee gateway is configured to acquire the identification of the Zigbee device carried in the control instruction; and the Zigbee gateway is further configured to forward the control instruction to the Zigbee device corresponding to the identification of the Zigbee device via the Zigbee chip, wherein a network type corresponding to the target network chip is different from that of a Zigbee network.

According to a fourth aspect of embodiments of the present disclosure, there is provided a non-transitory storage medium having stored therein instructions that, when executed by one or more processors of a sever for data communication, causes the server to perform: receiving a control instruction, wherein the control instruction carries identification of a Zigbee device; and forwarding the control instruction to a Zigbee gateway, wherein the Zigbee gateway is configured to receive the control instruction via a target network chip, the Zigbee gateway is further configured to acquire the identification of the Zigbee device carried in the control instruction, and the Zigbee gateway is further configured to forward the control instruction to the Zigbee device corresponding to the identification of the Zigbee device via the Zigbee chip, wherein a network type corresponding to the target network chip is different from that of a Zigbee network.

According to a fifth aspect of embodiments of the present disclosure, there is provided a Zigbee gateway, including: a control chip; a memory for storing instructions executable by the control chip, and a target network chip and a Zigbee chip connected with the control chip; wherein the control chip is configured to perform: receiving a control instruction via the target network chip, wherein the control instruction carries identification of the Zigbee device; acquiring the identification of the Zigbee device carried in the control instruction; and forwarding the control instruction to the Zigbee device corresponding to the identification via the Zigbee chip, wherein a network type corresponding to the target network chip is different from that of a Zigbee network.

The technical scheme according to embodiments of the present disclosure may have the following beneficial effects. The server receives a control instruction, wherein the control instruction carries identification of the Zigbee device; the server forwards the control instruction to the Zigbee gateway; and the Zigbee gateway forwards the control instruction to a Zigbee device. It solves the problem that a mobile terminal cannot send a control instruction to the Zigbee device; and by forwarding of the server, it achieves the effect that the mobile terminal only needs to communicate with the server, then addressing to the Zigbee gateway and the Zigbee device may be achieved by the server, and the mobile terminal may send the control instruction to the Zigbee device.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, and serve to explain the principles of the disclosure.

FIG. 1 is a block diagram of a system for data communication according to an exemplary embodiment of the present disclosure;

FIG. 2 is a flow chart illustrating a method for data communication according to an exemplary embodiment of the present disclosure;

FIG. 3 is a flow chart illustrating a method for data communication according to another exemplary embodiment of the present disclosure;

FIG. 4 is a flow chart illustrating a method for data communication according to another exemplary embodiment of the present disclosure;

FIG. 5 is a block diagram of an apparatus for data communication according to an exemplary embodiment of the present disclosure;

FIG. 6 is a block diagram of an apparatus for data communication according to another exemplary embodiment of the present disclosure;

FIG. 7 is a block diagram of an apparatus for data communication according to an exemplary embodiment of the present disclosure; and

FIG. 8 is a block diagram of a Zigbee gateway according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

The present disclosure takes a smart lamp as an example of a Zigbee device. Systems and methods are implemented in a scenario where a mobile terminal has a need to send a control instruction to the Zigbee device. The control instruction may be to turn on the smart lamp or turn off the smart lamp. However, because the Zigbee device is located in a Zigbee network provided by the Zigbee gateway, when the mobile terminal sends the control instruction to the Zigbee device, a problem need to be solved is addressing of the Zigbee gateway and the Zigbee device.

Further, the methods, devices, and modules described herein may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

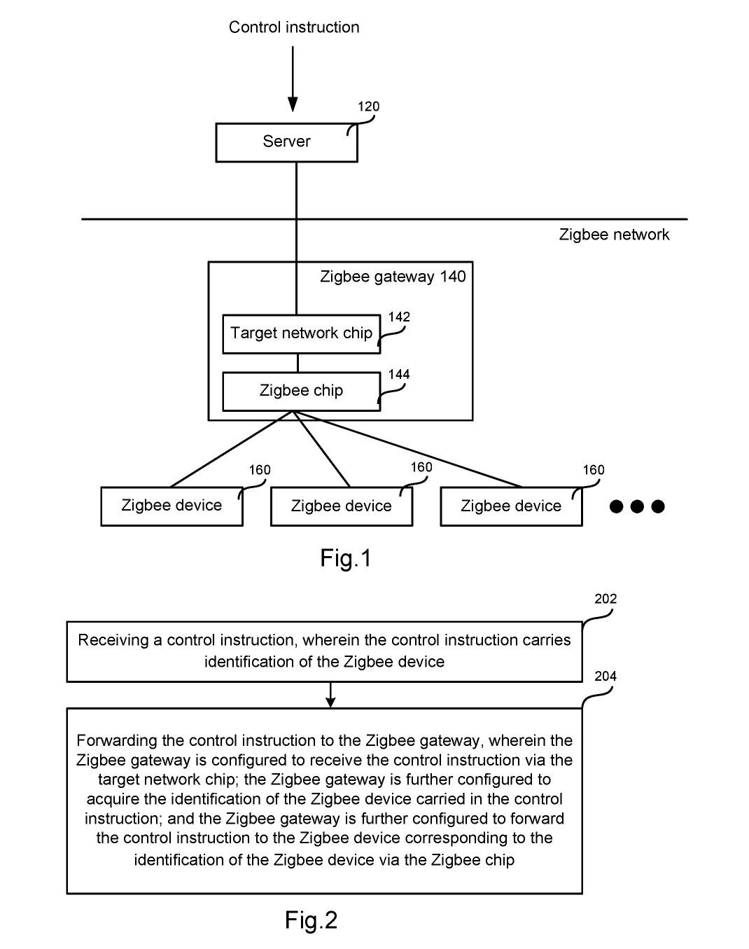

FIG. 1 is a block diagram of a system for data communication according to an exemplary embodiment of the present disclosure. The system may be a smart home system, and may include: a computer server 120, a Zigbee gateway 140 connected with the server 120, and at least one Zigbee device 160 connected with the Zigbee gateway 140.

A gateway is a node (e.g., a router) in a network, a key stopping point for data on its way to or from other networks. The Zigbee gateway 140 may be an electronic device that is configured to connect to a Zigbee network and a target network and configured to transmit data between the two networks and deliver the data from a first target device in the target network to a second target device in the Zigbee network or vice versa. For example, the Zigbee gateway may include a target network chip 142 to directly connect to the target network and a Zigbee chip 144 to directly connect to the Zigbee network. A device that supports the first target network but does not support Zigbee network may be connected to the Zigbee network or devices via the gateway.

The server 120 is configured to receive a control instruction, wherein the control instruction carries identification of the Zigbee device 160. The server 120 is further configured to forward the control instruction to the Zigbee gateway 140.

The Zigbee gateway 140 is configured to receive the control instruction sent by the server 120 via the target network chip 142; acquire the identification of the Zigbee device 160 carried in the control instruction; and forward the control instruction to the corresponding Zigbee device 160 via the Zigbee chip 144.

The Zigbee device 160 is configured to receive the control instruction forwarded by the Zigbee gateway 140, wherein a network type corresponding to the target network chip is different from that of a Zigbee network. For example, the network corresponding to the target network chip may be Internet, Bluetooth, or Wi-Fi, which adopts technologies that support high bit rate transmission but consumes large amount of energy, whereas the Zigbee network is typically used in low data rate applications that require long battery life and secure networking (ZigBee networks are secured by 128 bit symmetric encryption keys.) Typically, ZigBee has a defined rate of 250 kbit/s, best suited for intermittent data transmissions from a sensor or input device.

Accordingly, in the system for data communication provided by embodiments of the present disclosure, the server receives a control instruction, wherein the control instruction carries identification of the Zigbee device; the server forwards the control instruction to the Zigbee gateway according to the identification of the Zigbee device; and the Zigbee gateway forwards the control instruction to a Zigbee device according to the identification of the Zigbee device. The embodiment above solves the problem that a mobile terminal cannot send a control instruction to the Zigbee device; and by the forwarding function of the server, it achieves the effect that the mobile terminal only needs to communicate with the server, then addressing to the Zigbee gateway and the Zigbee device may be achieved by the server, and the mobile terminal may send the control instruction to the Zigbee device.

For example, based on the embodiment as shown in FIG. 1, the control instruction further carries identification of the Zigbee gateway 140; and the server 120 is configured to acquire the identification of the Zigbee gateway 140 carried in the control instruction; and forward the control instruction to the Zigbee gateway 140 according to the identification of the Zigbee gateway 140.

For example, based on the embodiment as shown in FIG. 1, the server 120 is configured to inquire identification of the Zigbee gateway 140 in a prestored corresponding relationship according to the identification of the Zigbee device 160; add the identification of the Zigbee gateway 140 to the control instruction; and send the control instruction to the Zigbee gateway 140 according to the identification of the Zigbee gateway 140.

For example, based on the embodiment as shown in FIG. 1, the Zigbee device 160 is further configured to report a corresponding relationship between the identification of the Zigbee gateway 140 and the identification of the Zigbee device 160 to the server 120 when the Zigbee device 160 accesses the Zigbee gateway 140; and the server 120 is configured to store the corresponding relationship.

For example, based on the embodiment as shown in FIG. 1, a network type corresponding to the target network chip is a Wi-Fi (Wireless-Fidelity) network; the identification of the Zigbee device is a MAC (Media Access Control) address; and the identification of the Zigbee gateway is a DID (device id).

FIG. 2 is a flow chart illustrating a method for data communication according to an exemplary embodiment of the present disclosure. The present embodiment takes the method for data communication being applied in the server as shown in FIG. 1 as an example. The method may include:

In step 202, receiving a control instruction, wherein the control instruction carries identification of a target Zigbee device. For example, the control instruction is a control instruction sent by a mobile device for turning on the smart lamp. For example, the identification of the target Zigbee device is a MAC address.

In step 204, forwarding and/or sending the control instruction to a target Zigbee gateway, wherein the Zigbee gateway is configured to receive the control instruction via the target network chip therein; the Zigbee gateway is further configured to acquire the identification of the target Zigbee device carried in the control instruction; and the Zigbee gateway is further configured to forward the control instruction to the target Zigbee device corresponding to the identification of the target Zigbee device via the Zigbee chip, wherein a network type corresponding to the target network chip is different from that of a Zigbee network.

Accordingly, in the method for data communication provided by the present embodiment, the server receives a control instruction, wherein the control instruction carries identification of the target Zigbee device; the server forwards the control instruction to the Zigbee gateway; and the Zigbee gateway forwards the control instruction to the target Zigbee device. It solves the problem that a mobile terminal cannot send a control instruction to the target Zigbee device; and by forwarding of the server, it achieves the effect that the mobile terminal only needs to communicate with the server without knowing the address of the Zigbee gateway. The addressing to the Zigbee gateway and the target Zigbee device may be achieved by the server, and the mobile terminal may send the control instruction to the target Zigbee device.

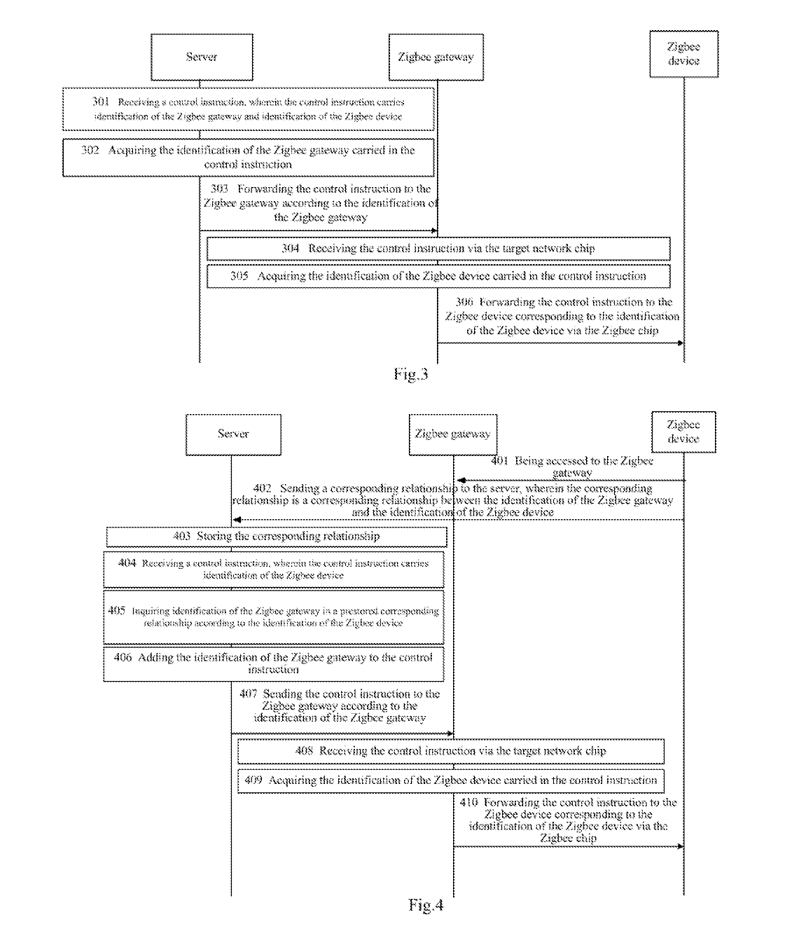

FIG. 3 is a flow chart illustrating a method for data communication according to another exemplary embodiment of the present disclosure. The present embodiment takes the method for data communication being applied in the system for data communication as shown in FIG. 1 as an example. The method may include:
in step 301, the server receives a control instruction, wherein the control instruction carries identification of the Zigbee gateway and identification of the target Zigbee device.

For example, the control instruction is a control instruction sent by a mobile device, for example an instruction to turn on the smart lamp.

For example, both the identification of the Zigbee gateway and the identification of the target Zigbee device are MAC addresses.

In step 302, the server acquires the identification of the Zigbee gateway carried in the control instruction;
in step 303, the server forwards the control instruction to the Zigbee gateway according to the identification of the Zigbee gateway;
in step 304, the Zigbee gateway receives the control instruction via the target network chip of the Zigbee gateway, wherein a network type corresponding to the target network chip is different from that of a Zigbee network. For example, the target network chip is a Wi-Fi chip.

In step 305, the Zigbee gateway acquires the identification of the target Zigbee device carried in the control instruction;
in step 306, the Zigbee gateway forwards and/or sends the control instruction to the target Zigbee device corresponding to the identification of the target Zigbee device via the Zigbee chip of the Zigbee gateway. For example, the Zigbee gateway may identify the target Zigbee device from a plurality of Zigbee devices in communication with it.

The target Zigbee device receives the control instruction from the Zigbee gateway, and preforms the control instruction.

Accordingly, in the method for data communication provided by the present embodiment, the server receives a control instruction, wherein the control instruction carries identification of the Zigbee gateway and identification of the target Zigbee device; the server forwards the control instruction to the Zigbee gateway according to the identification of the Zigbee gateway; and the Zigbee gateway forwards the control instruction to the target Zigbee device. It solves the problem that a mobile terminal cannot send a control instruction to the target Zigbee device; and by forwarding of the server, it achieves the effect that the mobile terminal only needs to communicate with the server, then addressing to the Zigbee gateway and the target Zigbee device may be achieved by the server, and the mobile terminal may send the control instruction to the target Zigbee device.

In the embodiment as shown in FIG. 3, the control instruction needs to carry both the identification of the Zigbee gateway and the identification of the target Zigbee device at the same time, which causes that the mobile terminal may generate and send the control instruction only when it knows the two identifications at the same time. In order to make the mobile terminal generate and send the control instruction easily, an embodiment as shown in FIG. 4 is provided.

FIG. 4 is a flow chart illustrating a method for data communication according to another exemplary embodiment of the present disclosure. The present embodiment takes the method for data communication being applied in the system for data communication as shown in FIG. 1 as an example. The method may include:
in step 401, the target Zigbee device accesses to the Zigbee gateway.

The target Zigbee device may establish a communication with and access to the Zigbee gateway, and the Zigbee gateway may be a gateway includes the target network chip and the Zigbee chip. For example, the target network chip is a Wi-Fi chip. That is, the Zigbee gateway has an ability to communicate both in the Wi-Fi network and the Zigbee network at the same time.

In step 402, the target Zigbee device sends a corresponding relationship to the server via its corresponding Zigbee gateway, wherein the corresponding relationship (i.e., correspondence) is a corresponding relationship between the identification of the Zigbee gateway and the identification of the target Zigbee device.

In order to send the corresponding relationship, the target Zigbee device may prestore an identification of the server, wherein the identification of the server may be an IP address of the server.

The target Zigbee device may establish a wireless communication with the Zigbee gateway. Then, after the target Zigbee device accesses to the Zigbee gateway, the corresponding relationship is reported to the server. The corresponding relationship is a corresponding relationship between the identification of the Zigbee gateway and the identification of the target Zigbee device.

For example, the identification of the Zigbee gateway is a DID, and the identification of the target Zigbee device is a MAC address. The DID is used in addressing a device (e.g., the Zigbee gateway) in the Wi-Fi network, and the MAC address is used in addressing a device (e.g., the target Zigbee device) in the Zigbee network.

In step 403, the server stores the corresponding relationship reported by respective Zigbee devices. Table 1 illustrates an example of the corresponding relationships:

TABLE 1

| | |
|---|---|
| MAC address 1 of a Zigbee device 1 | DID1 of a Zigbee gateway 1 |
| MAC address 2 of a Zigbee device 2 | DID1 of a Zigbee gateway 1 |
| MAC address 3 of a Zigbee device 3 | DID2 of a Zigbee gateway 2 |
| MAC address 4 of a Zigbee device 4 | DID2 of a Zigbee gateway 2 |
| MAC address 5 of a Zigbee device 5 | DID2 of a Zigbee gateway 2 |

In step 404, the server receives a control instruction, wherein the control instruction carries identification of the target Zigbee device. In the present embodiment, the control instruction only needs to carry the identification of the Zigbee device.

In step 405, the server inquires identification of the Zigbee gateway in the prestored corresponding relationship according to the identification of the target Zigbee device.

In step 406, the server adds the identification of the Zigbee gateway to the control instruction. For example, the control instruction is “DID1 of a Zigbee gateway 1, MAC address 1 of a Zigbee device 1, a command of turning on”.

In step 407, the server sends the control instruction to the Zigbee gateway according to the identification of the Zigbee gateway. The DID is used in addressing a device in the Wi-Fi network. The server sends the control instruction to the Zigbee gateway according to the DID of the Zigbee gateway.

In step 408, the Zigbee gateway receives the control instruction via the target network chip, wherein a network type corresponding to the target network chip is different from that of a Zigbee network. For example, the target network chip is a Wi-Fi chip.

In step 409, the Zigbee gateway acquires the identification of the Zigbee device (i.e., target Zigbee device) carried in the control instruction and identifies the target Zigbee device through the identification;

In step 410, the Zigbee gateway forwards the control instruction to the target Zigbee device corresponding to the identification of the target Zigbee device via the Zigbee chip. The target Zigbee device receives the control instruction, and preforms the control instruction.

Accordingly, in the method for data communication provided by the present embodiment, the server receives a control instruction, wherein the control instruction carries identification of the target Zigbee device; the server inquires identification of the Zigbee gateway in a prestored corresponding relationship according to the identification of the target Zigbee device, and forwards the control instruction to the Zigbee gateway according to the identification of the Zigbee gateway; and the Zigbee gateway forwards the control instruction to the target Zigbee device. It solves the problem that a mobile terminal cannot send a control instruction to the target Zigbee device; and by forwarding of the server, it achieves the effect that the mobile terminal only needs to communicate with the server, then addressing to the Zigbee gateway and the target Zigbee device may be achieved by the server, and the mobile terminal may send the control instruction to the Zigbee device.

In the method for data communication provided by the present embodiment, since the corresponding relationship between the identification of the Zigbee device and the identification of the target Zigbee gateway is prestored in the server, only the identification of the target Zigbee device needs to be carried when the control instruction is generated, which reduces the difficulty in generating the control instruction.

In an exemplary example, a user purchases a smart lamp which adopts the Zigbee technology. The manufacturer of the smart lamp further sets up a server providing backstage service in the Internet. The user installs application programs provided by the manufacturer in his cellphone. For example, the smart lamp may provide a two-dimension code on its housing for the user's cellphone to scan. The user may scan the two-dimension code through the application program to acquire the MAC address of the smart lamp. Once the MAC address is obtained, the cellphone may bind the smart lamp as a smart home device in the user's home. When the smart lamp accesses the Zigbee gateway, the corresponding relationship between the MAC address and the DID of the Zigbee gateway is sent to the server. The server saves the corresponding relationship.

If the user needs to turn on the smart lamp, he/she clicks an “on” button in the application program. Then the application program generates a turning on control instruction carrying the MAC address of the smart lamp. The application program sends the turning on control instruction to the server. The DID of the Zigbee gateway is searched by the server according to the MAC address of the smart lamp, and the server adds the DID of the Zigbee gateway to the control instruction for turning one the lamp. Then the server sends the turning on instruction to the Zigbee gateway. After the Zigbee gateway receives the turning on control instruction, the turning on control instruction is sent to the smart lamp according to the MAC address of the smart lamp. The smart lamp is turned on according to the turning on control instruction.

In the following embodiments of apparatuses according to the present disclosure, the apparatuses may be configured to perform the method in the above embodiments of the present disclosure. Details not disclosed in the embodiments of apparatuses may be referred to the embodiments of methods.

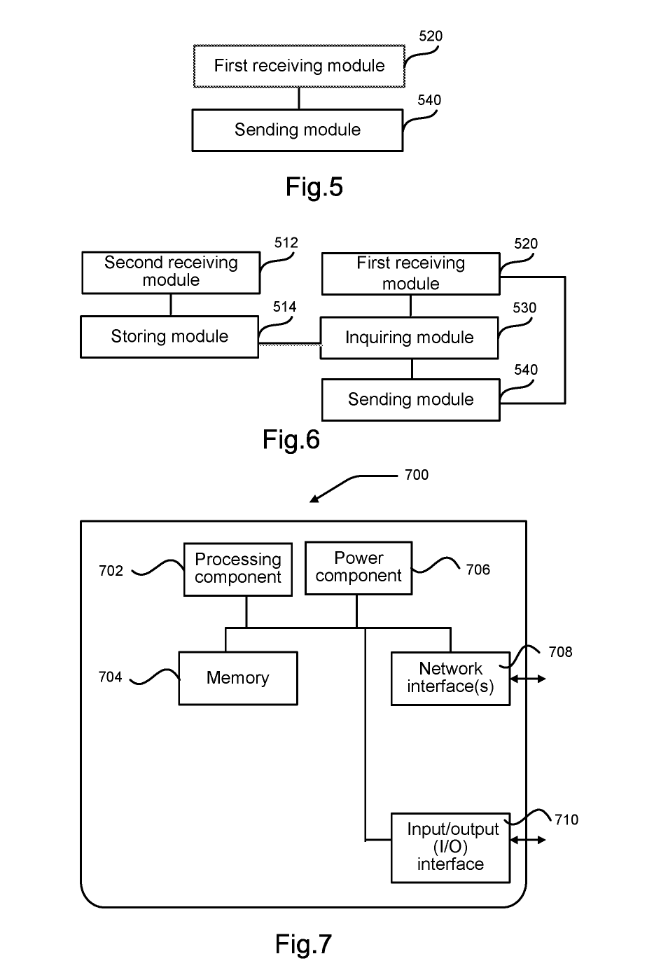

FIG. 5 is a block diagram of an apparatus for data communication according to an exemplary embodiment of the present disclosure. As shown in FIG. 5, the apparatus for data communication may constitute all or a part of the server as shown in FIG. 1 by software, hardware or a combination thereof. The apparatus may include, but not limited to:
a first receiving module 520 configured to receive a control instruction, wherein the control instruction carries identification of the target Zigbee device; and
a sending module 540 configured to forward the control instruction to the Zigbee gateway, wherein the Zigbee gateway is configured to receive the control instruction via the target network chip; the Zigbee gateway is further configured to acquire the identification of the target Zigbee device carried in the control instruction; and the Zigbee gateway is further configured to forward the control instruction to the target Zigbee device corresponding to the identification of the target Zigbee device via the Zigbee chip,
wherein a network type corresponding to the target network chip is different from that of a Zigbee network.

Accordingly, in the apparatus for data communication provided by the present embodiment, a control instruction is received, wherein the control instruction carries identification of the target Zigbee device; the control instruction is forwarded to the Zigbee gateway; and the Zigbee gateway forwards the control instruction to the target Zigbee device. It solves the problem that a mobile terminal cannot send a control instruction to the target Zigbee device; and by forwarding of the server, it achieves the effect that the mobile terminal only needs to communicate with the server, then addressing to the Zigbee gateway and addressing to the target Zigbee device may be achieved by the apparatus for data communication, and the mobile terminal may send the control instruction to the target Zigbee device.

FIG. 6 is a block diagram of an apparatus for data communication according to an exemplary embodiment of the present disclosure. As shown in FIG. 6, the apparatus for data communication may constitute all or a part of the server as shown in FIG. 1 by software, hardware or a combination thereof.

The apparatus may include, but not limited to: a first receiving module 520 configured to receive a control instruction, wherein the control instruction carries identification of the target Zigbee device; and a sending module 540 configured to forward the control instruction to the Zigbee gateway, wherein the Zigbee gateway is configured to receive the control instruction via the target network chip; the Zigbee gateway is further configured to acquire the identification of the target Zigbee device carried in the control instruction; and the Zigbee gateway is further configured to forward the control instruction to the target Zigbee device corresponding to the identification of the target Zigbee device via the Zigbee chip, wherein a network type corresponding to the target network chip is different from that of a Zigbee network.

In a first possible implementation, the control instruction carries the identification of the target Zigbee device; and the sending module 540 is configured to acquire identification of the Zigbee gateway carried in the control instruction; and forward the control instruction to the Zigbee gateway according to the identification of the Zigbee gateway.

In a second possible implementation, the apparatus further may include: an inquiring module 530 configured to inquire identification of the Zigbee gateway in a prestored corresponding relationship according to the identification of the target Zigbee device, wherein the sending module 540 configured to add the identification of the Zigbee gateway to the control instruction; and send the control instruction to the Zigbee gateway according to the identification of the Zigbee gateway.

In a second possible implementation, the apparatus further may include: a second receiving module 512 configured to receive a corresponding relationship sent by the target Zigbee device, wherein the corresponding relationship is reported when the target Zigbee device accesses to the Zigbee gateway; and the corresponding relationship is a corresponding relationship between the identification of the Zigbee gateway and the identification of the target Zigbee device; and a storing module 514 configured to store the corresponding relationship.

For example, a network type corresponding to the target network chip is a wireless fidelity network; the identification of the target Zigbee device is a MAC address; and the identification of the Zigbee gateway is a DID.

With respect to the apparatuses in the above embodiments, the specific manners for performing operations for individual modules therein have been described in detail in the embodiments regarding the relevant methods, which will not be elaborated herein.

One exemplary embodiment of the present disclosure provides an apparatus for data communication, which can implement the method for data communication provided by the present disclosure. The apparatus for data communication may include: a processor; and a memory for storing instructions executable by the processor, wherein the processor is configured to perform:
Receiving a control instruction, wherein the control instruction carries identification of the target Zigbee device; and
Forwarding the control instruction to the Zigbee gateway, wherein the Zigbee gateway is configured to receive the control instruction via the target network chip; the Zigbee gateway is configured to acquire the identification of the target Zigbee device carried in the control instruction; and the Zigbee gateway is further configured to forward the control instruction to the target Zigbee device corresponding to the identification of the target Zigbee device via the Zigbee chip, wherein a network type corresponding to the target network chip is different from that of a Zigbee network.

FIG. 7 is a block diagram of an apparatus for data communication according to another exemplary embodiment of the present disclosure. The apparatus may be a computer server as shown in FIG. 1. For example, the apparatus 700 may be provided as a device at a network side. Referring to FIG. 7, the apparatus 700 may include a processing component 702 that further may include one or more processors, and memory resources represented by a memory 704, which stores a set of instructions executable by the processing component 702, such as application programs. The application programs stored in the memory 704 may include one or more modules each corresponding to a set of instructions. Further, the processing component 702 is configured to execute the instructions to perform the above described method for data communication.

The apparatus 700 may further include a power component 706 configured to perform power management of the apparatus 700, wired or wireless network interface(s) 708 configured to connect the apparatus 700 to a network, and an input/output (I/O) interface 710. The apparatus 700 may operate based on an operating system stored in the memory 704, such as Windows Server™, Mac OS X™, Unix™, Linux™, FreeBSD™, or the like.

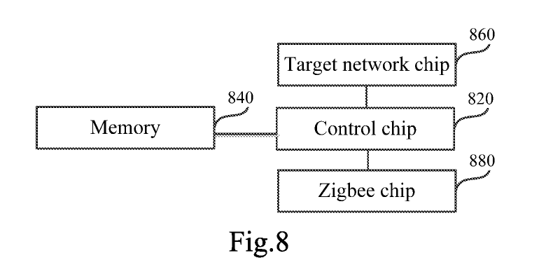

FIG. 8 is a block diagram of a Zigbee gateway according to another embodiment. The gateway may be the gateway 140 in FIG. 1 and may include: a control chip 820; a nontransitory memory 840 for storing a set of instructions executable by the control chip 820, and a target network chip 860 and a Zigbee chip 880 connected with the control chip 820; wherein the control chip 820 is configured to execute the set of instructions to perform:
Receiving the control instruction via the target network chip 860, wherein the control instruction carries identification of the target Zigbee device;
Acquiring the identification of the target Zigbee device carried in the control instruction; and
Forwarding the control instruction to the target Zigbee device corresponding to the identification via the Zigbee chip, wherein a network type corresponding to the target network chip is different from that of a Zigbee network.

Other embodiments of the disclosure will be apparent to those skilled in the art from consideration of the specification and practice of the disclosure disclosed here. This application is intended to cover any variations, uses, or adoptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A Zigbee gateway, comprising:
a storage medium comprising a set of instructions enabling the gateway to transmit data between a mobile smart terminal connected to a target network and a Zigbee network, and
a control chip in communication with the storage medium,
wherein when executing the set of instructions, the control chip is directed to:
establish a connection with each of at least one Zigbee device via the Zigbee network;
receive, via the target network, a control instruction from the mobile smart terminal carrying an identification of a target Zigbee device, wherein the target Zigbee device is one of the at least one Zigbee device; and
send the control instruction to the target Zigbee device via the Zigbee network according to the identification.

2. The Zigbee gateway of claim 1, wherein the target network is a different type of network from the Zigbee network.

3. The Zigbee gateway of claim 1, wherein the target network is an Internet network, Bluetooth network, or a Wi-Fi network.

4. The Zigbee gateway of claim 1, wherein the identification is a MAC (Media Access Control) address of the target Zigbee device.

5. The Zigbee gateway of claim 1, wherein the target Zigbee device is at least one of a smog sensor, a smart lamp, an electrical meter with in-home-display, or a traffic management system that is able to connect to the Zigbee network.

6. The Zigbee gateway of claim 1, further comprising:
a Zigbee chip in connection with the control unit, configured to connect the Zigbee gateway to the Zigbee network; and
a target network chip in connection with the control unit, configured to connect the Zigbee gateway to the target network.

7. The Zigbee gateway of claim 1, wherein the instruction is sent from a server and the instruction.

8. A method for data transmission between a target network and a Zigbee network, comprising:
establishing, by a Zigbee gateway apparatus, a connection with each of at least one Zigbee device via the Zigbee network;
receiving, by the Zigbee gateway apparatus via the target network, a control instruction carrying an identification of a target Zigbee device, wherein the target Zigbee device is one of the at least one Zigbee device; and
sending, by the Zigbee gateway apparatus, the control instruction to the target Zigbee device via the Zigbee network.

9. The method of claim 8, wherein the target network is a different type of network from the Zigbee network.

10. The method of claim 8, wherein the target network is an Internet network, Bluetooth network, or a Wi-Fi network.

11. The method of claim 8, wherein the identification is a MAC (Media Access Control) address of the target Zigbee device.

12. The method of claim 8, wherein the target Zigbee device is at least one of a smog sensor, a smart lamp, an electrical meter with in-home-display, or a traffic management system that is able to connect to the Zigbee network.

13. The method of claim 8, wherein the Zigbee gateway apparatus comprises:
a Zigbee chip configured to connect the Zigbee gateway apparatus to the Zigbee network; and
a target network chip configured to connect the Zigbee gateway apparatus to the target network.

14. The method of claim 8, wherein the instruction is sent from a server and the instruction.

15. A nontransitory storage medium, comprising a set of instruction for data transmission between a target network and a Zigbee network through a Zigbee gateway apparatus, wherein when the set of instruction is executed by the Zigbee gateway, directs the Zigbee gateway apparatus to perform:
establish a connection with each of at least one Zigbee device via the Zigbee network;
receiving, via the target network, a control instruction carrying an identification of a target Zigbee device, wherein the target Zigbee device is one of the at least one Zigbee device; and
sending, by the Zigbee gateway, the control instruction to the target Zigbee device via the Zigbee network.

16. The storage medium of claim 15, wherein the target network is a different type of network from the Zigbee network.

17. The storage medium of claim 15, wherein the target network is an Internet network, Bluetooth network, or a Wi-Fi network.

18. The storage medium of claim 15, wherein the identification is a MAC (Media Access Control) address of the target Zigbee device.

19. The storage medium of claim 15, wherein the target Zigbee device is at least one of a smog sensor, a smart lamp, an electrical meter with in-home-display, or a traffic management system that is able to connect to the Zigbee network.

20. The storage medium of claim 15, wherein the Zigbee gateway apparatus comprises:
a Zigbee chip configured to connect the Zigbee gateway apparatus to the Zigbee network; and
a target network chip configured to connect the Zigbee gateway apparatus to the target network.
